(19) United States
(12) Patent Application Publication
(10) Pub. No.: US 2007/0037114 A1
(43) Pub. Date: Feb. 15, 2007

(54) Light directing apparatus for whitening

(76) Inventor: Shu-Lung Wang, Taipei Hsien (TW)

Correspondence Address: BIRCH STEWART KOLASCH & BIRCH, PO BOX 747, FALLS CHURCH, VA, 22040-0747, US

(21) Appl. No.: 11/203,234

(22) Filed: Aug. 15, 2005

(51) Int. Cl. A61C 3/00

(52) U.S. Cl. 433/29

(57) ABSTRACT

A light directing apparatus for whitening aims to transmit light to project the front teeth of users for whitening purpose. It includes a duct for transmitting the light, a shell which has a housing space and a light penetrative member located in the housing apace. The duct has a coupling ring on one end. The shell has a coupling end corresponding to the coupling ring so that the shell can be coupled with the duct. The apparatus thus formed has an enhanced heat dissipation effect.

### FIELD OF THE INVENTION

The present invention relates to a light directing apparatus for whitening and particularly to a light directing apparatus for whitening purpose that has a shell coupling with a light transmitting duct to facilitate heat dissipation.

### BACKGROUND OF THE INVENTION

To have white teeth is a goal pursued by many people. However, many people have the teeth tarnished or stained due to drinking tea, smoking, eating betel nuts, or taking medicines. This could result in lost of self-esteem of the people. In recent years whitening teeth has become very fashionable. One of the teeth whitening techniques used in the dentistry is to coat a whitening agent on the surface of teeth, then project light through laser, plasma lamp, halogen lamp, compound metal lamp or the like to enable the whitening agent to be permeated into the teeth to remove pigment.

To carry out the aforesaid whitening process has to rely on a teeth whitening projection apparatus. The apparatus mainly includes a light projection device, a flexible light directing duct, and a light penetrative member. The light penetrative member, through the light directing duct which is coupled with the light projection device, receives light generated by the light projection device and projects the light in a desired direction.

R.O.C. Patent Publication No. M252388 discloses a “Light directing teeth arch” for whitening teeth. It mainly includes a coupling duct and a light penetrative member. The light penetrative member has a connecting portion to couple with one end of the coupling duct. The light directing duct has a head on one end containing a magnet. The head can be coupled with the opening of the coupling duct. Thereby light can be transmitted through the light directing duct and the coupling duct to the light penetrative member, and dispersed through an arched surface of the light penetrative member. The magnet on the head of the light directing duct can attract and couple with the magnetic metal duct to form a secured coupling. By moving the light directing teeth arch, the projecting direction and position of the light can be altered as desired.

The light penetrative member mentioned above is made from plastics or optical material. It is coupled with the coupling duct through the connecting portion. Such a design does not have a desired heat dissipation effect. As high temperature occurs when the light is generated, the connecting portion of the light penetrative member is damaged after a period of time, and the life span is shortened. Moreover, the light directing duct and the coupling duct are coupled magnetically. The magnetic switch on the light directing duct is easily breaking off during operation. It is not convenient.

### SUMMARY OF THE INVENTION

Therefore the primary object of the present invention is to solve the aforesaid disadvantages. The invention provides a light directing apparatus for whitening that includes a duct for transmitting light, a shell which has a housing space, and a light penetrative member located in the housing space. The duct has a coupling ring on one end. The shell has a coupling end corresponding to the coupling ring to connect the shell with the duct. Therefore they can be coupled securely and also provide a desired heat dissipation effect.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention.

FIG. 2 is an exploded view of the present invention.

FIG. 3 is a cross-sectional view of the present invention.

FIG. 4 is a schematic view of the present invention in a use condition.

FIG. 5 is a perspective view of another embodiment of the present invention.

### DETAILED DESCRIPTION OF THE PREFERRED EMBODIMENTS

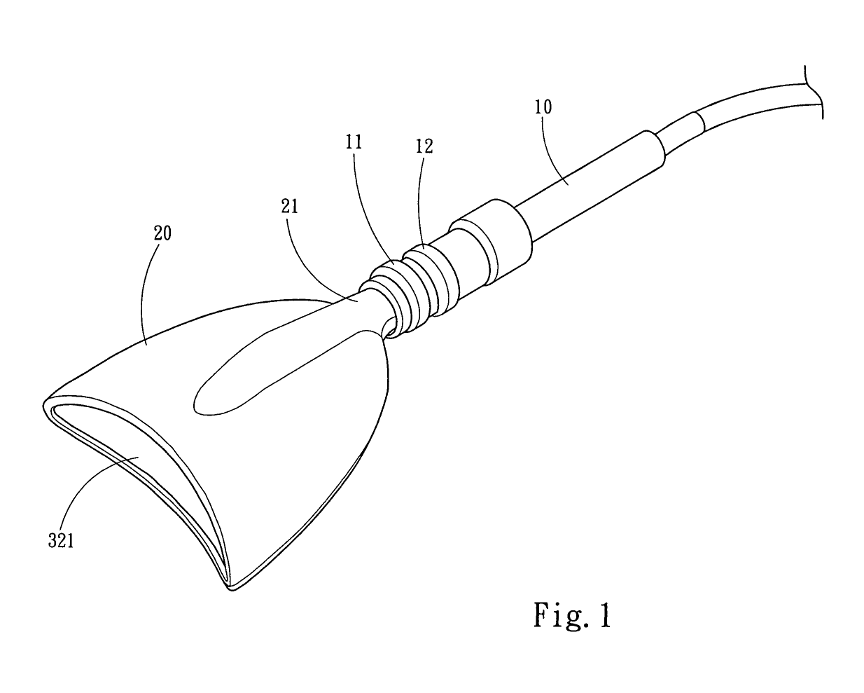

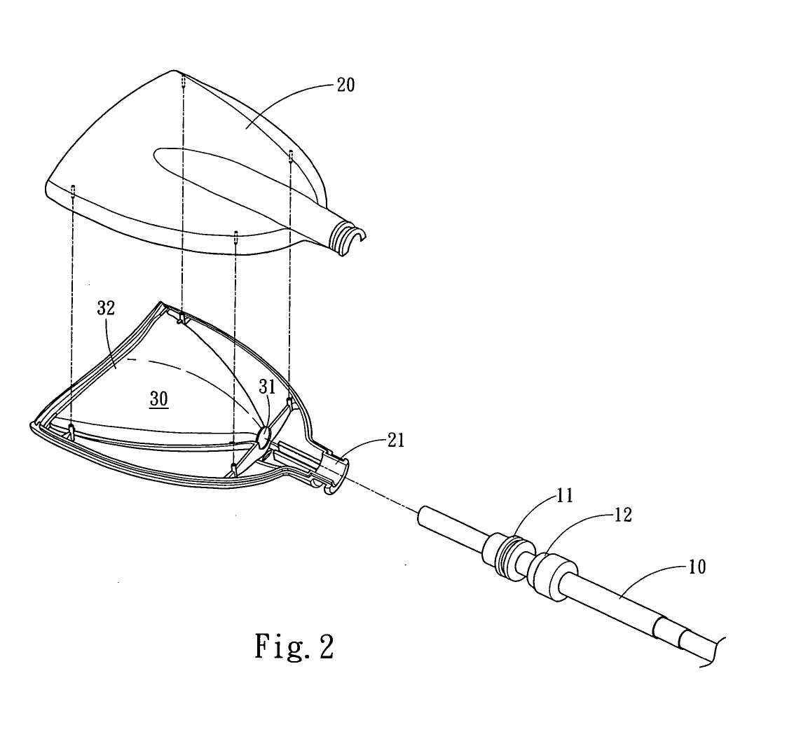

Please referring to FIGS. 1 and 2, the invention includes a duct 10 for transmitting light, a shell 20 which has a housing space and a light penetrative member 30 located in the housing space. The duct 10 has a coupling ring 11 on one end. The shell 20 has a coupling end 21 corresponding to the coupling ring 11 to couple the shell 20 with the duct 10. The duct 10 further has a magnetic switch 12 to activate or stop light transmission. The light penetrative member 30 is made from transparent plastics or optical material, and has a desired light permeability and conductivity. The light penetrative member 30 has a receiving end 31 to receive the light transmitted from the duct 10, and a dispersing portion 32 extended from the receiving end 31 that has a dispersing arched surface 321 to cover the front teeth (not shown in the drawings) of a user's mouth.

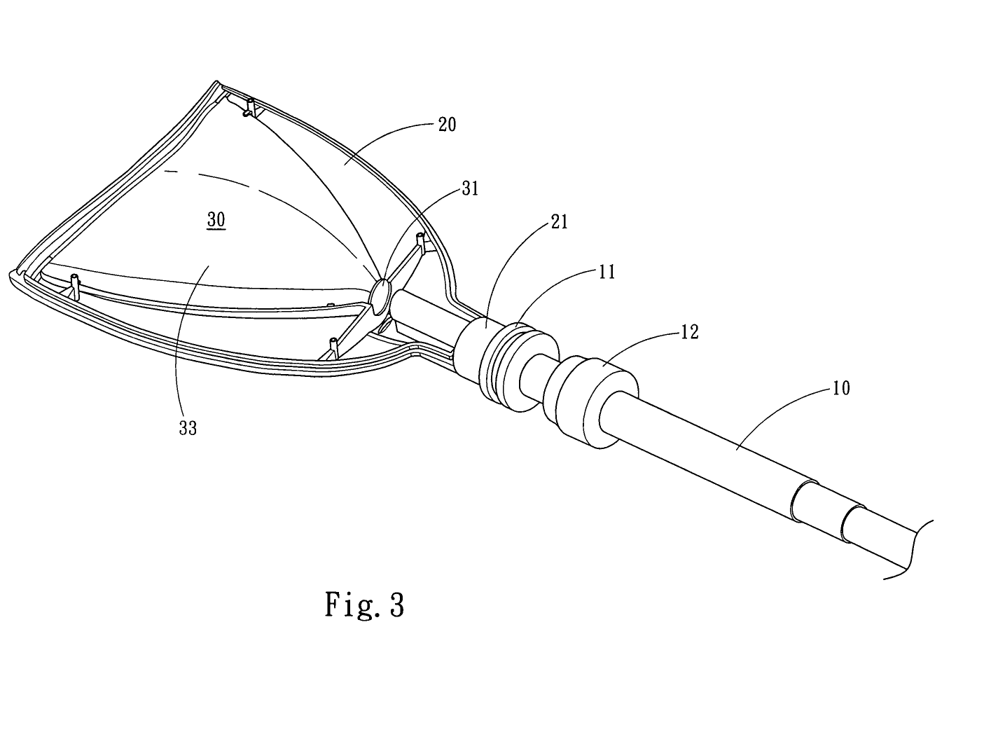

Referring to FIG. 3, the coupling ring 11 of the duct 10 is corresponding to the coupling end 21 of the shell 20 so that the shell 20 can be coupled with the duct 10. The receiving end 31 of the light penetrative member 30 corresponds to the duct 10, but is not coupled with the duct 10. Such a design can improve heat dissipation effect. The light penetrative member 30 has a plated surface 33 on the outer surface to enhance light converging effect.

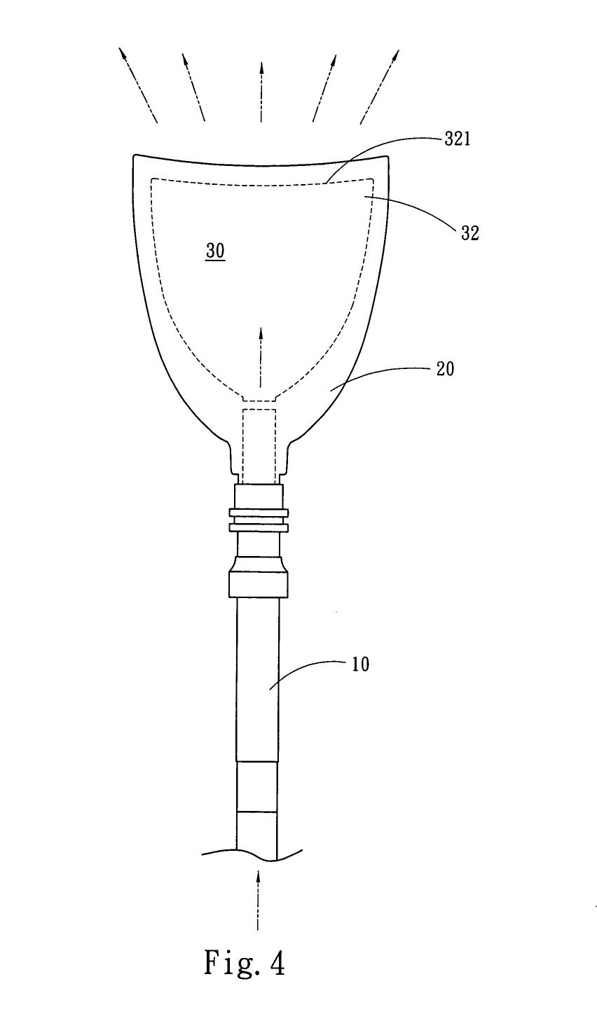

Refer to FIG. 4 for the invention in a use condition. The duct 10 is connected to a light emission device (not shown in the drawing). Light emitted from the light emission device is directed by the duct 10 to the light penetrative member 30 of the shell 20, then projects through the dispersing arched surface 321 to the front teeth (not shown in the drawing) of a user to perform whitening operation of the teeth.

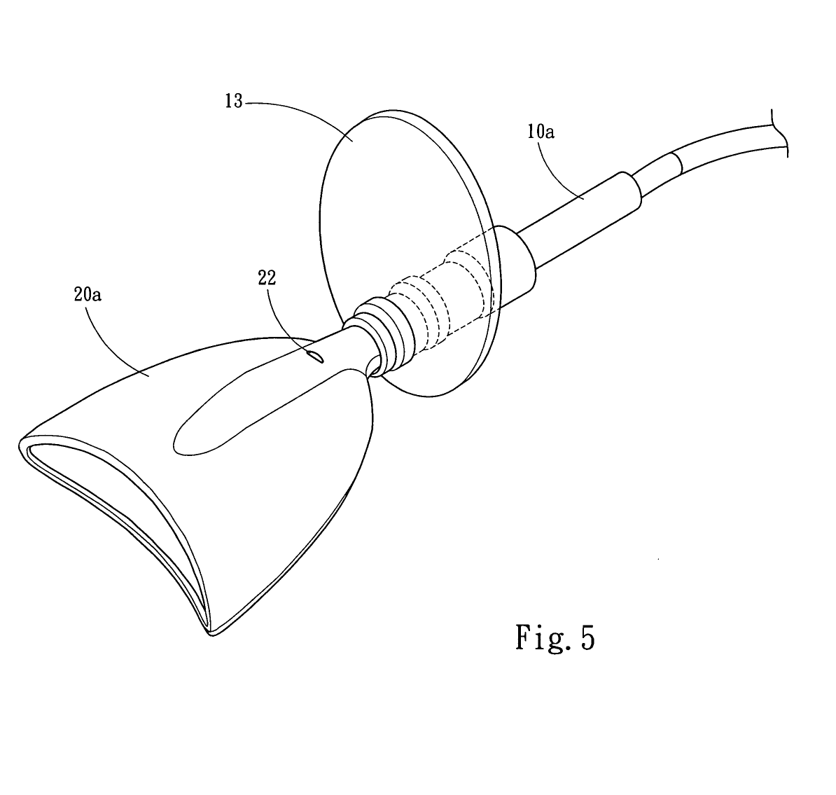

Refer to FIG. 5 for a perspective view of another embodiment of the invention. The shell 20a has cooling vents 22 on two opposite sides corresponding to the receiving end 31 of the light penetrative member 30. The cooling vents 22 can enhance heat dissipation effect through air convection. The duct 10a further is coupled with a mask 13 to shield light and protect operator's eyes from the harmful irritation of the strong light.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. A light directing apparatus for whitening, comprising:
a duct for transmitting light;
a shell coupling with the duct and having a housing space; and
a light penetrative member located in the housing space having a receiving end to receive the light transmitted through the duct and a dispersing portion to disperse the light.

2. The light directing apparatus of claim 1, wherein the duct has a coupling ring on one end and the shell has a coupling end corresponding to and coupled with the coupling ring.

3. The light directing apparatus of claim 1, wherein the duct has a magnetic switch to activate and stop light transmission.

4. The light directing apparatus of claim 1, wherein the duct is coupled with a mask to shield the light.

5. The light directing apparatus of claim 1, wherein the shell has at least one cooling vent corresponding to the receiving end of the light penetrative member.

6. The light directing apparatus of claim 1, wherein the light penetrative member has a light dispersing arched surface.

7. The light directing apparatus of claim 1, wherein the light penetrative member has a plated surface on an outer side.
